(19) United States
(12) Patent Application Publication
(10) Pub. No.: US 2020/0380860 A1
(43) Pub. Date: Dec. 3, 2020

(54) SMART CONTRACT FORMATION, HANDLING AND FULFILMENT BETWEEN VEHICLES

(71) Applicant: FORD GLOBAL TECHNOLOGIES, LLC, Dearborn, MI (US)

(72) Inventors: Perry Robinson MacNeille, Lathrup Village, MI (US); Kwaku O. Prakah-Asante, Commerce Twp., MI (US)

(21) Appl. No.: 16/423,768

(22) Filed: May 28, 2019

(51) Int. Cl. G08G 1/01; G08G 1/0968; G06Q 30/02; G06Q 20/36; H04W 4/46

(52) U.S. Cl. CPC G08G 1/0145; G08G 1/096833; H04W 4/46; G06Q 20/367; G06Q 30/0283

(57) ABSTRACT

An entity includes an antenna and a processor, and the entity can form a physical network one or more other entities via the antenna and configure a virtual topology for the physical network. The entity may also determine a desired action that will result in a traffic state change that will impact travel of at least one vehicle of the physical network. The entity may determine a payment to the at least one vehicle and form a digital agreement for payment, subsequent to the impact, to the at least one vehicle. The entity may further wirelessly transfer the agreement to one of the other entities of the physical network and then wirelessly receive the agreement after transfer, having been digitally signed by any vehicles determined to be impacted. Following receiving the agreement after transfer, the entity may execute the desired action, responsive to receiving the agreement after transfer.

### TECHNICAL FIELD

The illustrative embodiments generally relate to methods and apparatuses for smart contract formation, handling and fulfillment between vehicles.

### BACKGROUND

Traffic control systems are becoming smarter, with the ability to adapt to dynamic traffic conditions and provide smart scheduling of traffic. These systems often can favor large groups of users, or certain types of users (e.g., busses), over individuals. Even when the traffic comprises personal vehicles, the system can engage various control systems that may benefit one or more drivers to the detriment of others.

While drivers tend to accept changes to traffic control systems as a necessary part of travel, systems that favor certain drivers too aggressively may be viewed as being undesirable. Systems that balance fairness are better received, but such systems are hard to devise if fairness is measured purely in terms of traffic-impact or delay-impact. Many people would be willing to exchange money for brief inconvenience, but developing a system whereby millions of vehicles pay small amounts to millions of other vehicles in a near continuous cycle has proved a difficult solution to devise.

### SUMMARY

In a first illustrative embodiment, a system includes an antenna capable of establishing communication with an entity to form a physical network and a processor. The processor is configured to form a physical network one or more of the entities via the antenna and configure a virtual topology for the physical network. The processor is further configured to determine a desired action that will result in a traffic state change that will impact travel of at least one vehicle of the physical network. The processor is also configured to determine a payment to the at least one vehicle and form a digital agreement for payment, subsequent to the impact, to the at least one vehicle. Additionally, the processor is configured to wirelessly transfer the agreement to one of the entities of the physical network and then wirelessly receive the agreement after transfer, having been digitally signed by any vehicles determined to be impacted. Following receiving the agreement after transfer, the processor is configured to execute the desired action, responsive to receiving the agreement after transfer.

In a second illustrative embodiment a method includes determining that an object vehicle action will impact the travel of at least one other vehicle included in a wireless physical network controlled by a virtual topology. The method also includes generating a contract for payment to the other vehicle and wireless pass the contract around the physical network in an order dictated by the virtual topology. The method further includes receiving the contract, at the object vehicle, having been signed by all members of the physical network. Also, the method includes executing the object vehicle action responsive to receiving the contract and fulfilling the payment from the object vehicle to the other vehicle responsive to executing the object vehicle action.

In a third illustrative embodiment, a method includes receiving a digital contract between at least two vehicles in a physical network, having been signed by all vehicles in the physical network, and including confidence scores assigned by each vehicle in the physical network, for each other vehicle in the physical network, indicating an aggregate confidence that a given vehicle will fulfill any obligation defined by the digital contract. The method also includes, responsive to the confidence score for at least one vehicle being below a predetermined threshold, reforming the physical network exempting the at least one vehicle and sending a new contract to all the vehicles in the reformed physical network for digital signature and confidence score assignment.

### BRIEF DESCRIPTION OF THE DRAWINGS

FIG. 1 shows an illustrative example of overlapping ad-hoc formation networks;

FIG. 2 shows an illustrative process for contract-related phantom vehicle processing;

FIG. 3A shows an illustrative chain block;

FIG. 3B shows an illustrative smart contract;

FIG. 4 shows an illustrative formation creation process;

FIG. 5 shows an illustrative formation revision process; and

FIG. 6 shows an illustrative ledger assembly.

### DETAILED DESCRIPTION

As required, detailed embodiments are disclosed herein; it is to be understood, however, that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

There are a number of systems that can allow one driver to disadvantage (briefly) another driver to gain a traffic benefit. Without limitation, this can include, for example, a phantom vehicle creation. A phantom vehicle is a virtual construct which is known digitally to other vehicles and which can be treated as a real vehicle for purposes of affecting traffic flow. Phantom vehicles are discussed in co-pending and co-owned patent application 2018/111611, the contents of which are incorporated herein by reference.

For example, a phantom vehicle can be created immediately next to a vehicle that desires a merge. Since other vehicles may treat the phantom vehicle as real, the adaptive cruise controls of other vehicles will slow in reaction to the “presence” of the phantom vehicle, causing a gap to occur in traffic into which the real vehicle can merge. This slight delay for the slowing vehicles can be accommodated by payment, according to the illustrative embodiments and the like.

The illustrative embodiments are described with respect to phantom vehicle accommodation but are not remotely limited thereto. Using the smart contracting system discussed herein, and the like, small payments can be made for a variety of traffic accommodations, and even infrastructure can participate as a network member (e.g., a traffic light changes prematurely to accommodate a city bus, which may entitle all vehicles within X distance of the light that are now stopped to a nominal payment).

Also, without limitation, a crypto-currency for facilitating such transactions is briefly discussed, although the amounts could equally be paid in any real currency. With a crypto model, people could receive a fixed amount of credit each month, and drivers who were not in a hurry or who did not drive a lot could sell their currency to drivers who wanted to have as many slight driving advantages as possible. The same could be accomplished by simply paying for maneuvers with real currency, of course, so either payment for is suitable.

In the phantom vehicle concept, the phantom vehicle imposes a cost in terms of time and fuel consumption of other members of the formation. This cost can be resolved using smart contracts that allow a vehicle to create a phantom and pay for the use of a phantom later when the vehicle is parked near a server. Other use cases are also supported as appropriate, when traffic patterns or signals are changed to favor one driver or group of drivers over another driver or group.

One other example would be a merge lane, where some drivers race ahead to merge while others wait in line. If vehicles are autonomous, for example, or if a fairer solution is desired, any driver that races ahead may be required to buy the right to merge. That is, if vehicles or other drivers are paid for the cost of the merge, the driver that races ahead can be provided with a space to merge. This allows people to make a value judgment on whether they will wait and potentially collect money or race ahead and pay money.

Buying into the space can also be done using a phantom vehicle, which may hopefully avoid snap-waves of stop and go traffic such as currently exist when a driver races ahead and forces their way in, causing a wave of hard breaking. Drivers who are racing ahead to buy in can project a phantom vehicle ahead of their arrival, so that traffic can evenly slow to provide a space for them by the time they arrive.

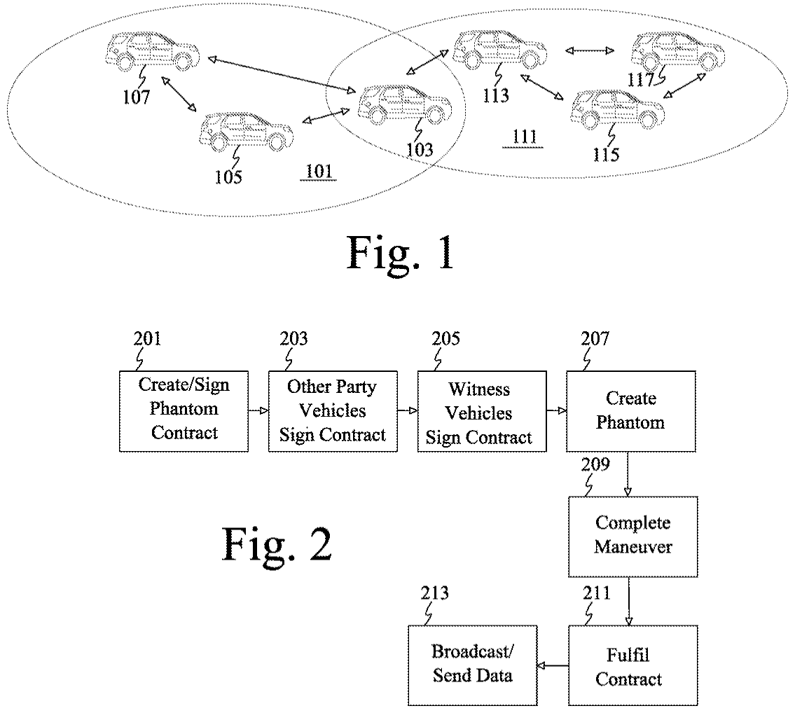

FIG. 1 shows an illustrative example of overlapping ad-hoc formation networks 101, 111. When a vehicle 103 is going to use a phantom vehicle or other traffic control feature that will potentially negatively affect some other vehicles, the vehicle 103 may create one or more dynamic ad-hoc network formations 101, 111.

For example, if vehicle 103 is going to create a phantom vehicle (not shown) that will affect vehicles 105 and 107, vehicle 103 may form a smart contract with vehicles 105 and 107 to pay those vehicles (typically a nominal amount, e.g., a few cents) for a slight delay caused by the cooperative adaptive cruise control (CACC) of vehicles 105 and 107 reacting to vehicle 103.

Antenna on vehicles 103, 105 and 107 can form a physical network, which can include directional antenna signals to establish the physical network. A virtual network topology can also be managed via software residing on the vehicles 103, 105, 107, so that a token ring network can be formed between all vehicles in a physical ad-hoc network, and the software can maintain the topology regardless of the physical connections, assuming at least one physical connection remains between each vehicle for the purpose of conveying the token and a ledger for tracking the contract.

At the same time, there are witnesses to the contract in the forms of vehicles 113, 115, 117, forming another physical network with vehicle 103 and having virtual topology in the form of a token ring. All of the vehicles shown can form a dual-token ring network or a single token ring network, with some vehicles acting as witnesses to a contract and other vehicles being parties to the contract.

Since vehicles constantly move in and out of connection, a network formation and smart contract may limit the network to include members present when the phantom vehicle is created, or just before the phantom vehicle is created. The contract may specify something along the lines of, for example, “vehicle 103 will create a phantom vehicle, vehicles 105 and 107 agree to react to the phantom vehicle via CACC, for each agreeing vehicle 105, 107 that reacts, a payment of $0.05 from vehicle 103 to a given reacting vehicle will be made.”

The illustrative embodiments present a crypto-contract method that facilitates the use of smart contracts within such a formation 101, 111 of vehicles to address unfairness caused by conflicting goals of individual vehicles such as 103 in the formation and the needs of the vehicle infrastructure.

The contract may stipulate that payment will be made via ordinary global transaction servers once the vehicle is parked. Contract fulfillment may be done automatically and cannot be reversed after the maneuver is complete. Validation of transactions may be done using a quorum approach which is much faster than the consensus system employed by cryptocurrencies and is more appropriate to very fast low cost contract acceptance. Synchronization of the quorum may be done using a token-ring network that requires much less computing power than Adam Back's Hashcash algorithm used by most cryptocurrencies.

Vehicles may be identified in the network by their public key, which is taken from a secure element in the vehicle electronics. As with most vehicle functions, it is assumed the vehicle manufacturer is a trusted authority and the public/private key are predetermined and meet all requirements, resulting in much higher performance for a high volume of low value contracts.

In this example, the vehicle 103 may need to change a lane, and vehicles 105 and 107 may be in the adjacent lane into which vehicle 103 desires to merge. The driver of vehicle 103 may signal a lane switch with the turn signal. The illustrative embodiments provide a system that automatically contracts with vehicles 105, 107 in the adjacent lane to create a gap in exchange for a contract guaranteeing payment when the vehicles are parked and connected to terrestrial networks.

At the same time, a different vehicle 103 maneuver may impact vehicles 113, 115, 117. Similar measures with regards to formation and contract establishment may occur between vehicles 103, 113, 115, 117. In this manner, each formation is relative to the impacted vehicles and can change to accommodate new vehicles in the formation or vehicles leaving the formation that will no longer be impacted by the proposed maneuver.

There may also be a confidence associated with a given vehicle, discussed more later. This confidence is based on a quorum, which is to say that all vehicles do not have to have a minimum confidence to proceed. Confidence may be based on, for example, a previous transaction experienced between two vehicles, and whether or not the paying vehicle actually fulfilled the contract. Confidence can be used to prevent a group of confederate vehicles from cheating another vehicle in the formation.

In a non-limiting, illustrative example, the vehicles may have three values for confidence, for example 0=does not pay, 1=unknown, 2=pays. In this example, vehicles not previously encountered are given the benefit of the doubt, and a confidence evaluation can take the form of “if the average confidence is 1 or higher, execute the contract.” This means, for example, that as long as no vehicles have ever encountered any other vehicle for which a confidence score is to be entered, all vehicles get the benefit of the doubt (the average will be 1). On the other hand, if there are more 0's than 2's, meaning more vehicles have experienced a given vehicle as a non-payor when that vehicle was supposed to pay, than have experienced the same vehicle fulfilling contracts, the score will be less than 1, and that vehicle will either be exempted from the contract or its phantom vehicle may be ignored (if it is the object vehicle 103) because the vehicles 105, 107 can expect non-payment based on historic behavior.

Drivers do not have to actively decide on any of the preceding, it can all be handled automatically based on records of previous interactions with vehicles. The cloud could also supply a confidence value for each vehicle not having a personal experience, which could be an average value of all transactions occurring with regards to a given vehicle (e.g., 0 if doesn't pay, 2 if pays, averaged over all transactions). If the cloud is supplying a value, there may be a greater penalty on non-payment, because otherwise users could effectively skip every other payment and still receive a baseline 1 rating, under the simplified system presented for example only.

The illustrative examples describing vehicle ad-hoc formation networks support the use of distributed ledgers for smart contracts. A single ledger may be shared between the vehicles in a formation 101, 111 and a concurrency mechanism is proposed to schedule updates of the ledger. Blocks that record contracts within a formation may be certified by consensus of quorum where the quorum is the vehicles in a formation.

When transactions occur between vehicles in adjacent vehicle formations the quorum is expanded to include vehicles in both formations 101, 111. A gateway vehicle 103 manages the internetworking between formations. The approach supports low-value contract establishment with latencies consistent with vehicle ad-hoc networks (100 milliseconds) that are done automatically by vehicle electronics. This can also include using vehicles 113, 115, 117 as witnesses to a contract, even if those vehicles are otherwise unaffected by the contract.

Physical wireless network connections are depicted in FIG. 1. These may be implemented as direct, point-to-point wireless links supported by beam-steering technology. Virtual network topologies within the formations may be supported by a communication module. In this example, one vehicle 103 has physical links to both formations 101, 111 and provides a gateway function that is implemented as an inter-communicator between the two virtual networks.

Bitcoin orders the creation of blocks on a blockchain using a proof-of-work concurrency scheme. Each server with a copy of the distributed ledger solves a problem that requires a random amount of time to solve. The first server to solve the problem provides proof to the other servers, and then adds a block to the chain. Other servers get the block and update their copy, ensuring concurrency across all servers. In the illustrative embodiments concurrency may not require consensus of all servers, only consensus within a formation, which is considered to be a quorum for the purpose of confirming confidence. Since there are nominal amounts of money interchanged, it may not be necessary to have all parties have full consensus (i.e., have seen the vehicle before and confirmed it), which also addresses the issue of many vehicles not having ever previously encountered other vehicles.

Ordering of block creation may be done by establishing a virtual token ring network within each formation 101, 111 so that transactions are only added to the ledger by a vehicle when it has a token. When a vehicle completes its transactions, it passes its tokens to the next vehicle in the ring. This helps ensure that the contract is passed in an orderly manner and that all participating members complete the contract in an ordered fashion.

FIG. 2 shows an illustrative process for contract-related phantom vehicle processing. This process may be executed by vehicle processors in communication in an ad-hoc formation network 101, for example. In this example, a first vehicle 103 may create and cryptographically sign a smart contract for a phantom vehicle to be created ahead of vehicles 105, 107 at 201. Vehicle 103 also establishes an ad-hoc network connection with vehicles 105 and 107 for contract verification and fulfillment.

Then, at 203, vehicles 105 and 107 sign the contract cryptographically, following delivery of the contract over the network to those vehicles 105, 107. In this example, the other vehicles 113, 115, 117 in the adjacent network 111 sign the contract cryptographically as witnesses at 205. The contract is passed around the full ring of all vehicles 101 and 111 in an ordered manner, to prevent multiple vehicles from trying to act at the same time in adjusting or signing a ledger.

Once the contract is signed at 207, the vehicle 103 creates a phantom vehicle ahead of vehicles 105 and 107 using a cooperative, adaptive cruise control (CACC) module at 209. The other vehicles 105 and 107 treat this vehicle as a real vehicle for traffic control purposes and may slow responsive to the phantom vehicle via their own respective CACC modules. This then entitles those vehicles 105, 107 to some form of remuneration.

The vehicle 103 completes the maneuver of lane-changing facilitated by the phantom vehicle or other construct at 211. The smart contract may then remain stored until the vehicle 103 returns to a base station. At that time, or another suitable time, the contract accounts between vehicles 103, 105, 107 or between vehicle 103 and other vehicles can be binned and settled with global transaction servers at 213. Vehicles 105, 107 both have copies of the witnessed contract demonstrating that they are entitled to payment, and vehicles 113, 115 and 117 have copies as witnesses. All vehicles have also signed the contract as participants or witnesses, so any copy of the contract should reveal which other vehicles can serve as witnesses if there is a dispute.

If it became a problem that people were faking contracts, any given witness vehicle or participant vehicle not directly involved in a transaction or dispute could be contacted to determine if they also held a valid, witnessed copy of the contract. It would be very difficult, if not impossible, to both fake witness signatures (signed uniquely by identifiers identifying specific non-party vehicles) and somehow save records of the contract onto the memory of the witness vehicles. Thus, a fast remote call to a witness vehicle along with a contract identifier should quickly serve to validate any disputed contract.

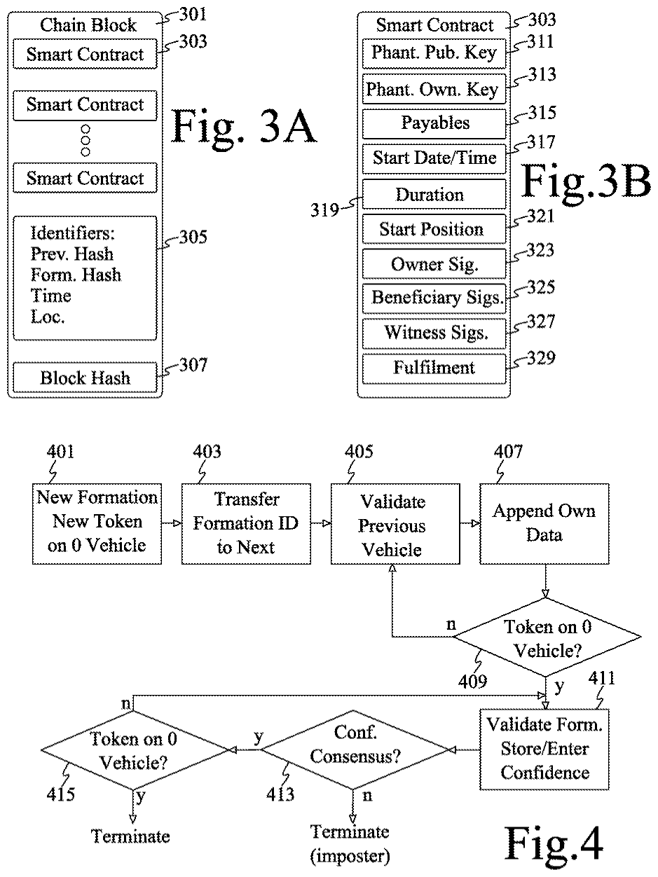

FIG. 3A shows an illustrative chain block 301 stored by, for example, vehicle 103. This block 301 consists of a plurality of smart contracts 303 established with respect to a vehicle 103 while the vehicle 103 is traveling. Example smart contracts include identifiers 305 such as, for example, a previous block hash, a formation hash, a time of contract and a location of contract establishment. Each maneuver may have a smart contract 303 associated therewith, and a vehicle 103 can deliver the block for binning and settlement when the vehicle 103 parks or reaches a destination base station.

A given smart contract 303 may have a copy stored by all participating vehicles (signatories) for validation purposes. With formation hashes and previous block hashes also stored, for example, as well as a time and location (in this example, but not all necessary), it is virtually impossible to fake a contract. Signatories to a contract/agreement and even paying or payee entities may include infrastructure elements as well. In some instances, an infrastructure element may be the payor, such as when traffic is rerouted or haled by the element to favor, for example, a public transport. In other instances, the element may be the only non-participant witness or a high-confidence witness (e.g., a digital short range communication transceiver deployed roadside) and may be a witness entity to a contract.

In some cases such infrastructure elements will be assigned default confidence values or automatic confidence values as they represent entities of the local municipality or government. In other instances, confidence voting will apply to these entities as well.

FIG. 3B shows an illustrative smart contract 303 in more detail. This smart contract was facilitated by a phantom vehicle, and so it includes the phantom vehicle public key 311, which is the network identifier of the phantom vehicle generated when the vehicle 103 generates a phantom vehicle. This contract also includes the phantom vehicle owner public key 313, which is the network identifier of the vehicle 103 that created the phantom vehicle. While the example is not limited to phantom vehicle creation, this is an example of how the event (phantom vehicle creation) occurrence can be appended into the contract to ensure that the event actually occurred. Elements 311 and 313 can essentially help prevent faking of a contract by a group of vehicles acting in concert to generate a contract with regards to another vehicle (e.g., 105, 107, 113, 115 and 117 collude to extract money from 103), because 103 would have to still provide the appropriate signature information after actually creating a phantom vehicle.

Moreover, with the nominal amounts of money proposed for transactions, if such amounts stay low enough, there may never be enough financial incentive to create fake contracts entitling someone to a certain level of payments. In addition, any fulfillment server can track the net amount of money flowing to a given entity, and if there is an anomalous event (e.g., the typical vehicle receives $1.45 a day and some vehicle X is receiving $200 a day), a number of the security features discussed herein, and the like, can be examined to ensure the validity of all contracts with vehicle X.

The contract may further include a list 315 of payables or receivables, which are public keys of vehicles 105, 107 receiving compensation for the vehicle 103 use of a phantom vehicle. The contract may also include the birth date and time of the phantom vehicle 317 and the duration of the phantom vehicle 319, either or both of which may impact the value of creation and the payment due. The payables may specify, for example, that upon phantom vehicle creation, vehicles 105 and 107 agree to use CACC to respond to the phantom vehicle and vehicle 103 will pay vehicles 105 and 107 $0.05 for the accommodation.

The contract may also track where in the formation the phantom vehicle will be created 321 and a key-based signature of vehicle 103, representing the owner of the contract 303. Vehicles 105 and 107 that are receiving payment may also sign the contract 303 in element 325, and witness vehicles 113, 115, 117 may further sign the contract. Finally, the contract may lock a time for cryptocurrencies at 329, which, if a variable value currency is used, entitles the vehicles 105, 107 to a fragmented value (e.g., 0.001 OEMCoins, an illustrative crypto-currency, based on the value at the lock moment). As long as vehicle 103 has more than 0.002 OEMCoins, then payment is not an issue, and if the vehicle 103 has less than that many coins in its account, then it will be required to obtain 0.002 OEMCoins on fulfillment, at a current rate, since the value of 0.001 OEMCoins at transaction time was worth the cost of the maneuver.

FIG. 4 shows an illustrative formation creation process executable by vehicles 103, 105, 107, 113, 115, 117 in one or more formations. In this example, when a new formation (new physical network addition) is created, such as by the addition or loss of a vehicle at 401, the linking vehicle or a designated vehicle 103 requesting the maneuver may create new contents of a formation identifier.

This can include, for example: for vehicle 103—a location, time and radio frequency (RF) fingerprint, a public key, a previous-formation hash and a hash of the preceding three items; and, for vehicles 105, 107, etc.—a location, time and RF identifier for each vehicle, a public key for each vehicle, a previous formation hash, and a hash of the preceding elements.

The identifier may also include a formation hash of the vehicles, and a confidence for each vehicle in the formation (added later as discussed below). The formation identifier is filled by passing the formation identifier from vehicle 0 (103) around the new token ring (the new virtual topology formed from the new physical network.

As previously noted, a vehicle can have a reputation representing relationships between vehicles. Each vehicle can add a confidence for the other vehicles in the network, which, as shown below, is added when the contract is passed around the token ring a second time (at which point every vehicle should have added its identifier, so every other vehicle can enter a confidence for all member vehicles.

In this example, after the new formation is created, the contents of the formation identifier may be transferred from vehicle 103 to the next vehicle (e.g., 105) in the network at 403. This vehicle 105 now has the token, and can validate data for previous vehicles at 405. (e.g. recompute the hash and verify a checksum) The vehicle 105 that has the token can append its own data to the formation identifier at 407, and provided the token is not back at the originating vehicle 103 at 409, the process can continue in a similar manner for a next vehicle 107.

Vehicle 0 can also specify participants and witnesses, which is one way to synchronize the data and if all participating and/or witness vehicles are specified in the formation identifier as the data is passed the first time, each vehicle can add a confidence for any other vehicle as appropriate.

When a contract is formed (an agreement between two network members, as multiple contracts can be formed and handled at once) a vehicle that wants to send the contract adds it into the token data when that vehicle has the token—the vehicle who the message is intended for takes the message out and passes along new added information if it exists.

Once the token returns to the originating vehicle 103, the vehicle 103 can validate formation membership and enter a confidence at 411. If there is not a confidence consensus for a given vehicle at 413 (and all vehicles have voted), the process can terminate. A new ring and network can be formed exempting the imposter vehicle. Once the token has passed back around to vehicle 0 (103 in the example), and each vehicle has “won” a confidence vote from the others (according to a predefined paradigm for winning a confidence vote, such as the example above), the contract formation is complete, the witnesses have signed and vehicle 103 can create the phantom vehicle to complete the action specified in the contract.

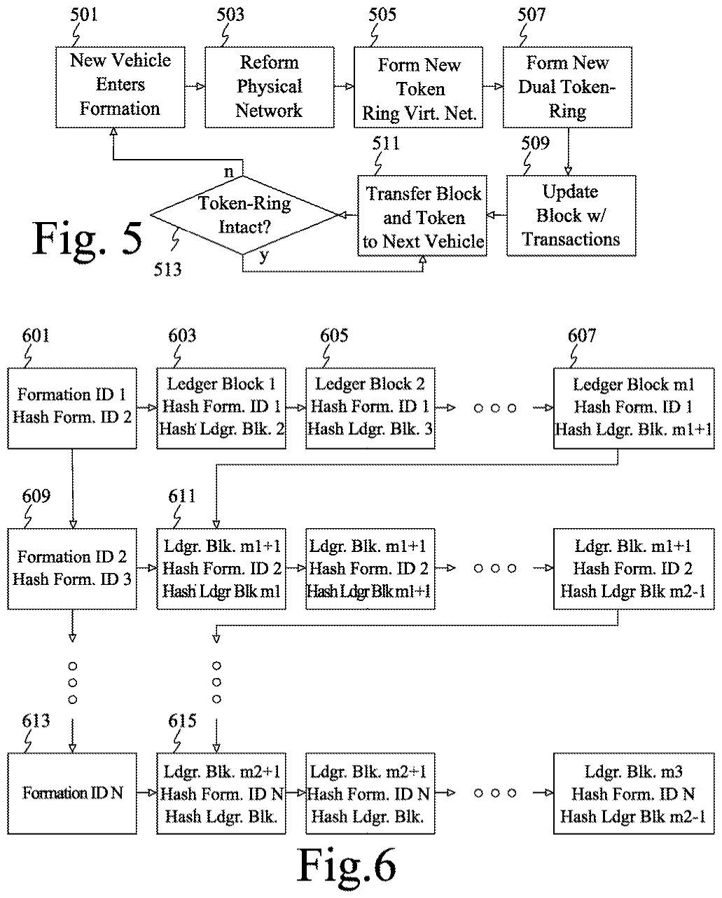

FIG. 5 shows an illustrative formation revision process, executable by, for example, a vehicle 103 processor or the processor of any other vehicle that currently holds the token for an existing token-ring. When a physical network disturbance occurs at 501, a new vehicle has entered the network. Each vehicle, in this example, includes a formation network manager to manage network formation, as well as token-ring communicators and dual token-ring communicators.

The formation network managers on the respective vehicles reform the physical network at 503 to accommodate the new vehicle, and token-ring communicators on each vehicle work in concert to reform a virtual token-ring network at 505, which is a virtual network. Dual token-ring communicators on each vehicle in a formation 101 and in adjacent formations 111 cooperate to form a dual token-ring network at 507 if that formation is also used.

The vehicle in the token ring that currently owns the ring-token updates the chain block with transactions originating or terminating on that block and witnesses transactions between vehicles at 509. The block's hashes are updated as well and the block and token are transferred to the next vehicle in the ring at 511. These transactions may be timestamped by a satellite navigation system and GPS stamped. The token ring ensures that only one vehicle writes to the current writable block at a time, preventing a double-spend attack. This is the standard example process previously discussed, with the only change being that a new virtual token ring was just formed, so the whole process of cycling any unfinalized contracts around the ring simply repeats for the new ring (which may include a new witness or a new payee).

If the token-ring is still intact (no disturbances), the vehicle holding the token advances the token and current writable block to the next vehicle in the ring at 513, where that vehicle updates the block with transactions, witnesses transactions, and updates the hashes.

FIG. 6 shows an illustrative ledger assembly. All of the data shown is not necessarily immediately present, for example, the block 601 holding a hash of Formation ID 2 will not have the hash of Formation ID 2 added until Formation ID 2 actually exists.

Before formation ID 2 exists, while formation ID 1 is still intact, each ledger block of formation ID 1 represents data added by a given vehicle. So, for example, vehicle 103 adds ledger block 1, which includes the hash of Formation ID 1. The vehicle 103 would then pass this ledger block to vehicle 105, which both adds ledger block 2 605 and adds a hash of ledger block 2 to ledger block 1. The same process is repeated for each additional vehicle, which adds its own ledger block with its own information, as well as adding a hash of its personal ledger block to the previous block to ensure an ordered record of block creation is held by a preceding block.

When a new formation is formed at 609, the new formation ID 2 hash is added to 601, which is a second record of the new formation in an independent record, which again preserves the integrity of the chain by reference (and for validation purposes). Then, with the new formation, the creating vehicle creates ledger block 611, as discussed above with regards to 603. The ledger chain is preserved (e.g., this is not ledger block 1, but rather ledger block of the last numbered block of formation ID 1+1), but the new ledger blocks record the new formation ID.

Until the transactions are completed (e.g., the phantom vehicle has been created, in the illustrative-only example), the formations can dynamically adapt with new formation ID creation such as 613 and new ledger block creation such as 615. This preserves an ordered record of which formations existed as well as any ledger blocks (with order preserved by previous ledger blocks) created during the interaction event culminating in phantom vehicle or other traffic accommodation occurrence.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired.

With respect to the illustrative embodiments described in the figures showing illustrative process flows, it is noted that a general-purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situational suitable variations of embodiments described herein.

What is claimed is:

1. A system comprising:
an antenna configured to establish communication with entities to form a physical network; and
a processor configured to
form a physical network with one or more of the entities via the antenna,
configure a virtual topology for the physical network,
determine a desired action resulting in a traffic state change affecting travel of at least one vehicle of the physical network,
determine a payment to the at least one vehicle,
form a digital agreement for the payment, subsequent to the traffic state change, to the at least one vehicle,
wirelessly transfer the agreement to one of the entities of the physical network,
wirelessly receive the agreement after the transfer, the agreement having been digitally signed by any vehicles determined to be affected by the traffic state change, and
execute the desired action, responsive to receiving the agreement as signed.

2. The system of claim 1, wherein the processor is included in a vehicle.

3. The system of claim 2, wherein the entity includes other vehicles.

4. The system of claim 2, wherein the entity includes infrastructure elements.

5. The system of claim 2, wherein the payment is from an account associated with the vehicle including the processor.

6. The system of claim 1, wherein the processor is included in an infrastructure element.

7. The system of claim 1, wherein the virtual topology includes a token ring network.

8. The system of claim 1, wherein the traffic state change includes delaying the at least one vehicle.

9. The system of claim 1, wherein the traffic state change includes causing the at least one vehicle to change lanes.

10. The system of claim 1, wherein the traffic state change includes re-routing the at least one vehicle.

11. The system of claim 1, wherein the wireless transfers to the at least one vehicle and at least one non-impacted vehicle are performed in an ordered manner dictated by the virtual topology, such that only one vehicle is able to modify the agreement at any given time.

12. The system of claim 1, wherein the wireless transfer of the agreement to one of the entities includes wirelessly transferring the agreement to the at least one vehicle for digital signature by the at least one vehicle.

13. The system of claim 1, wherein the wireless transfer of the agreement to one of the entities includes wirelessly transferring the agreement to at least one non-impacted vehicle in the physical network for digital signature as a witness vehicle.

14. The system of claim 1, wherein the wireless transfer of the agreement to one of the entities includes wirelessly transferring the agreement to an infrastructure element for digital signature as a witness entity.

15. The system of claim 1, wherein the agreement further includes a confidence value, for at least a paying entity of the physical network, from which the payment will be obtained, amendable by each entity receiving and digitally signing the agreement and representing aggregate confidence of paying the payment for any entity for which a confidence value is defined.

16. The system of claim 1, wherein the agreement further includes a confidence value, for each entity of the physical network, wherein confidence values of other entities in the physical network are amendable by each entity receiving and digitally signing the agreement, and wherein confidence values represent aggregate confidence of the entities of the physical network that a given entity of the physical network will fulfill any obligation resulting from the agreement.

17. The system of claim 16, wherein the processor is configured to execute the desired action further responsive to confirming that confidence values of all entities of the physical network are above a predefined threshold value, following receiving the agreement after transfer.

18. The system of claim 17, wherein the processor is configured to exclude any entity for which confidence values are below the predefined threshold value from a newly formed physical network and virtual topology, formed responsive to one or more entities having confidence values below the predefined threshold following receiving the agreement after transfer, and to repeat the process of determining the desired action, determining the payment, forming the digital agreement, wirelessly transferring the agreement and wirelessly receiving the agreement within the newly formed physical network.

19. A method comprising:
determining that an action of an object vehicle will affect travel of at least one other vehicle included in a wireless physical network controlled by a virtual topology;
generating a contract for payment to the other vehicle and wireless pass the contract around the physical network in an order dictated by the virtual topology;
receiving the contract, at the object vehicle, having been signed by all members of the physical network;
executing the object vehicle action responsive to receiving the contract; and
fulfilling the payment from the object vehicle to the at least one other vehicle responsive to executing the object vehicle action.

20. A method comprising:
receiving a digital contract between at least two vehicles in a physical network, the contract having been signed by all vehicles in the physical network and including confidence scores assigned by each vehicle in the physical network, that, for each other vehicle in the physical network, indicate an aggregate confidence that a given vehicle will fulfill any obligation defined by the digital contract; and
responsive to the confidence score for at least one vehicle being below a predetermined threshold, reforming the physical network exempting the at least one vehicle and sending a new contract to all the vehicles in the reformed physical network for digital signature and confidence score assignment.
